(19) United States
(12) Patent Application Publication
(10) Pub. No.: US 2025/0060019 A1
(43) Pub. Date: Feb. 20, 2025

(54) SHOCK ABSORBER

(71) Applicant: KYB Corporation, Tokyo (JP)

(72) Inventors: Naoki YASUKOUCHI, Tokyo (JP); Naoki HASEGAWA, Tokyo (JP)

(73) Assignee: KYB Corporation, Tokyo (JP)

(21) Appl. No.: 18/724,203

(22) PCT Filed: Feb. 6, 2023
(86) PCT No.: PCT/JP2023/003883

§ 371 Date: Jun. 26, 2024

(30) Foreign Application Priority Data
Feb. 4, 2022 (JP) 2022-015993

(51) Int. Cl. F16F 13/00

(52) U.S. Cl. CPC F16F 13/007; F16F 2230/0005; F16F 2230/0052

(57) ABSTRACT

A shock absorber of the present invention includes a cylinder, a piston slidably inserted into the cylinder, a piston rod movably inserted into the cylinder, a rebound spring including a coil spring disposed on an outer periphery of the piston rod and an annular lower collar attached to the coil spring, and an annular support facing the lower collar in an axial direction and supporting a piston side end of the lower collar, in which the support includes a cylindrical portion attached to the outer periphery of the piston rod, and a receiving portion that is annular, has an inner periphery connected to an anti-piston side end of the cylindrical portion, faces a piston side end of the lower collar in the axial direction, and is capable of abutting on the lower collar, and a regulating portion that regulates eccentricity of the lower collar with respect to the receiving portion is provided.

### TECHNICAL FIELD

The present invention relates to a shock absorber.

### BACKGROUND ART

Conventionally, in a shock absorber, a rebound spring constituted by a coil spring having resin collars attached at both ends is interposed between a rod guide that seals a cylinder end portion and pivotally supports a piston rod and a support that is welded to an intermediate portion of the piston rod and has a flange-like receiving portion. The rebound spring is sandwiched and compressed between the rod guide and the receiving portion of the support, which are close to each other when the shock absorber is extended, to thereby exert a spring force for suppressing extension of the shock absorber and alleviate impact when the shock absorber is maximally extended.

Then, for example, a rebound spring disclosed in JP 2015-148268 A includes a coil spring, and a resin upper collar and resin lower collars that are respectively fitted to inner circumferences of both ends of the coil spring.

The lower collar serves to fix the coil spring to an outer periphery of the piston rod, while the upper collar faces the piston rod with a gap therebetween and is displaced with respect to the piston rod. Thus, the piston side end of the coil spring is fixed by the lower collar, but an anti-piston side end is a free end, and when the upper collar abuts on the rod guide or a cushion rubber provided at a lower end of the rod guide, the coil spring contracts and exerts a spring force to suppress extension of the shock absorber.

### CITATION LIST

### Patent Literature

Patent Literature 1: JP 2015-148268 A

### SUMMARY OF INVENTION

### Technical Problem

As illustrated in FIG. 7, the support 100 described above includes a cylindrical portion 100a welded and fixed to the piston rod 101, and a flange-shaped receiving portion 100b having an inner periphery connected to an anti-piston side end of the cylindrical portion 100a, and an angle formed by the receiving portion 100b and the cylindrical portion 100a is a right angle.

As described above, when a rebound spring 102 contracts at the time of extension of the shock absorber, a spring force is exerted to press a lower collar 103 against the receiving portion 100b of the support 100 configured as described above, but when a lateral force acts on the shock absorber and a lateral force acts on the rod 104, the rebound spring 102 may become eccentric with respect to the support 100. When the rebound spring 102 becomes eccentric with respect to the support 100 in this manner, the lower collar 103 is also displaced in the radial direction with respect to the support 100.

When the lower collar 103 becomes eccentric with respect to the support 100 and is displaced in the radial direction as described above, a line of action of the spring force generated by compression of the rebound spring 102 is displaced to an outer peripheral side of the receiving portion 100b, and a large moment is applied to the receiving portion 100b. Then, as indicated by a broken line in FIG. 7, the outer periphery of the receiving portion 100b of the support 100 may be deformed so as to be bent toward the cylindrical portion side, and a seat portion 103a abutting on the support 100 of the lower collar 103 and the fitting portion 103b fitted to the rebound spring 102 may be damaged. In order to prevent such deformation of the support 100, it is necessary to increase the thickness of the support 100, but this increases the manufacturing cost and weight of the shock absorber.

Therefore, an object of the present invention is to provide a shock absorber capable of preventing deformation of a support without causing an increase in manufacturing cost and weight.

### Solution to Problem

In order to solve the above object, a shock absorber according to the present invention includes a cylinder, a piston slidably inserted into the cylinder, a piston rod movably inserted into the cylinder and having one end connected to the piston, a rebound spring including a coil spring disposed on an outer periphery of the piston rod and an annular lower collar attached to a piston side end of the coil spring and fitted to the outer periphery of the piston rod, and an annular support attached to the outer periphery of the piston rod, facing the lower collar in an axial direction, and supporting a piston side end of the lower collar, in which the support includes a cylindrical portion attached to the outer periphery of the piston rod, and a receiving portion that is annular, has an inner periphery connected to an anti-piston side end of the cylindrical portion, faces a piston side end of the lower collar in the axial direction, and is capable of abutting on the lower collar, and a regulating portion that regulates eccentricity of the lower collar with respect to the receiving portion is provided.

With the shock absorber configured as described above, even if the rebound spring becomes eccentric with respect to the support while contracting at the time of extension of the shock absorber, it is possible to suppress deformation in which the outer periphery of the receiving portion in the support is bent toward the cylindrical portion by the spring force received from the rebound spring.

### BRIEF DESCRIPTION OF DRAWINGS

FIG. 1 is a cross-sectional view of a shock absorber according to an embodiment of the present invention.

FIG. 2 is an enlarged longitudinal sectional view of a support portion of the shock absorber according to the embodiment of the present invention.

FIG. 3 is an enlarged longitudinal sectional view of a rebound spring of the shock absorber according to the embodiment of the present invention.

FIG. 4 is an enlarged longitudinal sectional view of a support portion of a shock absorber in a first modification of one embodiment of the present invention.

FIG. 5 is an enlarged longitudinal sectional view of a support portion of a shock absorber in a second modification of one embodiment of the present invention.

FIG. 6(a) is an enlarged longitudinal sectional view of a support portion of a shock absorber in a third modification of one embodiment of the present invention. FIG. 6(b) is an enlarged longitudinal sectional view of a support portion of a shock absorber in a fourth modification of the embodiment of the present invention.

FIG. 7 is an enlarged longitudinal sectional view of a conventional support.

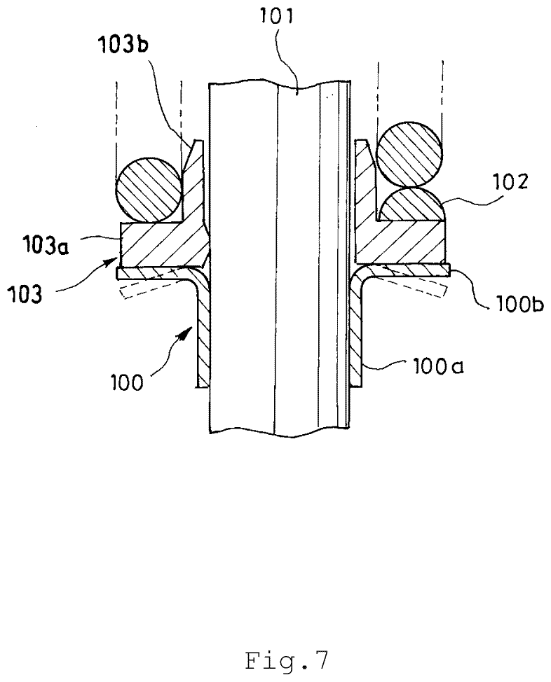

### DESCRIPTION OF EMBODIMENTS

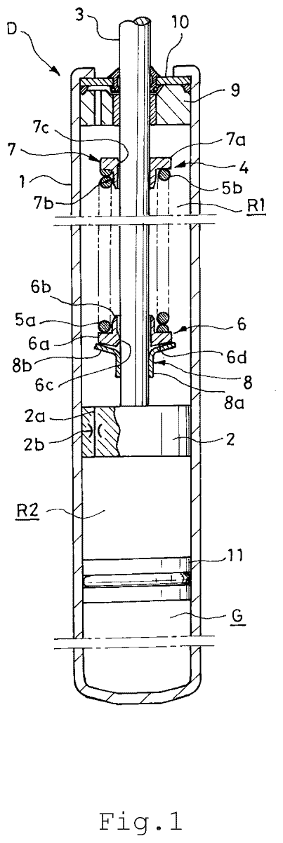

Hereinafter, an embodiment of the present invention will be described with reference to the drawings. As illustrated in FIG. 1, the shock absorber D in one embodiment includes a cylinder 1, a piston 2 slidably inserted into the cylinder 1, a piston rod 3 movably inserted into the cylinder 1 and having one end connected to the piston, a rebound spring 4 having a coil spring 5 and a lower collar 6 attached to a piston side end 5a of the coil spring 5, and an annular support 8 facing the lower collar 6 in an axial direction and supporting a piston side end of the lower collar 6.

Hereinafter, each unit will be described in detail. The cylinder 1 has a bottomed cylindrical shape, and an annular rod guide 9 is attached to an upper end in FIG. 1. The rod guide 9 seals an upper end opening of the cylinder 1 and the piston rod 3 is inserted through an inner periphery, and slidably supports the piston rod 3. In addition, a seal member 10 in sliding contact with an outer periphery of the piston rod 3 is fixed to the cylinder 1 in an overlapping state above the rod guide 9 in FIG. 1 on an atmosphere side, and the outer periphery of the piston rod 3 is sealed. The seal member 10 also seals between the cylinder 1 and the outer periphery of the rod guide 9, and the inside of the cylinder 1 is liquid-tightly sealed.

Then, the inside of the cylinder 1 is partitioned into an extension side chamber R1 above the piston 2 in FIG. 1 and a compression side chamber R2 below the piston 2 in FIG. 1 by the piston 2 inserted into the cylinder 1, and the extension side chamber R1 and the compression side chamber R2 are filled with a liquid such as hydraulic oil. Further, in the shock absorber D, a free piston 11 is slidably inserted into the cylinder 1 below the piston 2, and a gas chamber G filled with gas is formed below the free piston 11 in the cylinder 1.

The piston 2 is provided with a passage 2a communicating the extension side chamber R1 and the compression side chamber R2, and a damping valve 2b as a damping force generating element provided partway in the passage 2a. When the shock absorber D extends and the extension side chamber R1 is compressed by the piston 2, the liquid in the extension side chamber R1 passes through the passage 2a and moves to the compression side chamber R2. Then, the damping valve 2b gives resistance to the flow of the liquid, so that the pressure of the extension side chamber R1 increases, and a difference occurs between the pressure of the extension side chamber R1 and the pressure of the compression side chamber R2. Further, when the shock absorber D contracts, the compression side chamber R2 is compressed by the piston 2, and the liquid in the compression side chamber R2 passes through the passage 2a and moves to the extension side chamber R1. Then, the damping valve 2b gives resistance to the flow of the liquid, so that the pressure of the compression side chamber R2 increases, and a difference occurs between the pressure of the compression side chamber R2 and the pressure of the extension side chamber R1.

As described above, during the extension operation of the shock absorber D, the pressure of the extension side chamber R1 becomes higher than the pressure of the compression side chamber R2, the pressure of the extension side chamber R1 acts on the piston 2 by the differential pressure of the pressure of the compression side chamber R2, and the shock absorber D outputs a damping force that hinders upward movement of the piston 2 in FIG. 1. On the other hand, during the contraction operation of the shock absorber D, the pressure of the compression side chamber R2 becomes higher than the pressure of the extension side chamber R1, the differential pressure between the pressure of the compression side chamber R2 and the pressure of the extension side chamber R1 acts on the piston 2, and the shock absorber D outputs a damping force that hinders downward movement of the piston 2 in FIG. 1.

Note that, in the case of the shock absorber D, when the shock absorber D extends and contracts, the piston rod 3 moves into and out of the cylinder 1, so that the volume of the piston rod 3 pushed away in the cylinder 1 changes. This volume change is compensated by the free piston 11 moving up and down in the cylinder 1 to change the volume of the gas chamber G. As described above, the shock absorber D is what is called a single-rod monotube shock absorber, but may be a multi-tube shock absorber in which an outer tube or a tank is provided outside the cylinder 1, a reservoir filled with gas and liquid is formed between the outer tube and the cylinder 1 or in the tank, and a change in displacement volume of the piston rod 3 is compensated by the reservoir. In addition, the shock absorber D may be a double rod type shock absorber in which the piston rod 3 is inserted into the extension side chamber R1 and the compression side chamber R2.

In addition, although the damping valve 2b provided in the piston 2 is an orifice that allows both flow of the liquid from the extension side chamber R1 to the compression side chamber R2 and reverse flow of the liquid from the compression side chamber R2 to the extension side chamber R1 in this case, a plurality of passages 2a may be provided, a damping valve that allows only flow of the liquid from the extension side chamber R1 to the compression side chamber R2 may be provided in a part of the passages, and a damping valve that allows only flow of the liquid from the compression side chamber R2 to the extension side chamber R1 may be provided in all of the remaining passages. Furthermore, the passage 2a and the damping valve 2b can be provided in addition to the piston 2, and can be provided, for example, on the piston rod 3 or outside the cylinder 1.

In the piston rod 3, the piston 2 is attached to a distal end which is a lower end in FIG. 1, and an upper end in FIG. 1 protrudes to the outside of the cylinder 1 through an inner periphery of the rod guide 9. Further, the support 8 is fixed to the outer periphery of the piston rod 3 on the lower side in FIG. 1 by welding.

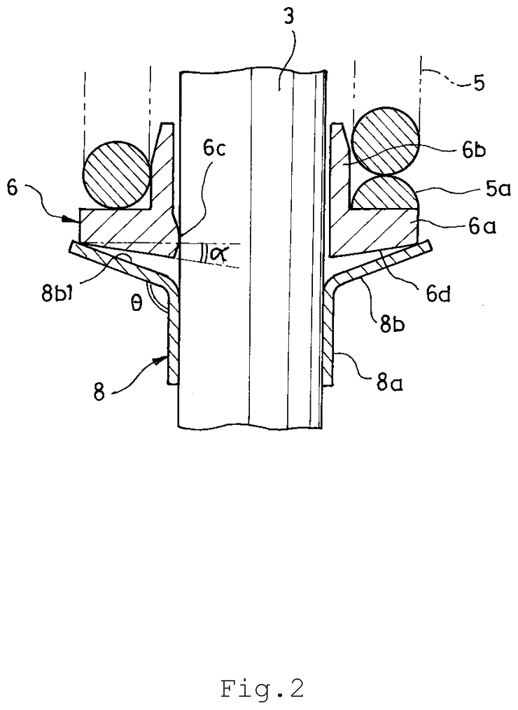

As illustrated in FIGS. 1 and 2, the support 8 includes a cylindrical portion 8a attached to the outer periphery of the piston rod 3, and a receiving portion 8b having an annular shape and an inner periphery connected to an anti-piston side end of the cylindrical portion 8a, and is formed by radially expanding and deforming a pipe member at an intermediate portion in the axial direction. In addition, an angle θ formed by the receiving portion 8b and the cylindrical portion 8a in a cross section of the support 8 is larger than 90 degrees and is 110 degrees, and the receiving portion 8b is inclined so as to be gradually separated from the piston rod 3 toward the outer periphery, and includes a tapered inclined surface 8b1 on the anti-piston side. The support 8 configured as described above is fixed to the piston rod 3 by inserting the piston rod 3 into the cylindrical portion 8a, fitting the cylindrical portion 8a to a predetermined position on the outer periphery of the piston rod 3, and then attaching the cylindrical portion 8a to the outer periphery of the piston rod 3 by projection welding. In the shock absorber D of the present embodiment, a regulating portion that regulates eccentricity of the lower collar 6 with respect to the receiving portion 8b of the support 8 is formed by setting the angle θ formed by the receiving portion 8b and the cylindrical portion 8a in the cross section of the support 8 to be larger than 90 degrees. Note that, when the regulating portion is formed by setting the angle θ formed by the receiving portion 8b and the cylindrical portion 8a to an angle larger than 90 degrees, the angle θ only needs to be any angle larger than 90 degrees, but from the viewpoint of supporting the lower collar 6, an angle obtained by subtracting 90 degrees from the angle θ is preferably set in a range from 10 degrees to 35 degrees.

As described above, the rebound spring 4 includes the coil spring 5 into which the piston rod 3 is inserted and which is disposed on the outer periphery of the piston rod 3, the annular lower collar 6 attached to the piston side end 5a, which is the lower end in FIG. 1 of the coil spring 5, and fitted to the outer periphery of the piston rod 3, and an annular upper collar 7 attached to the anti-piston side end, which is the upper end in FIG. 1 of the coil spring 5, and disposed on the outer periphery of the piston rod 3.

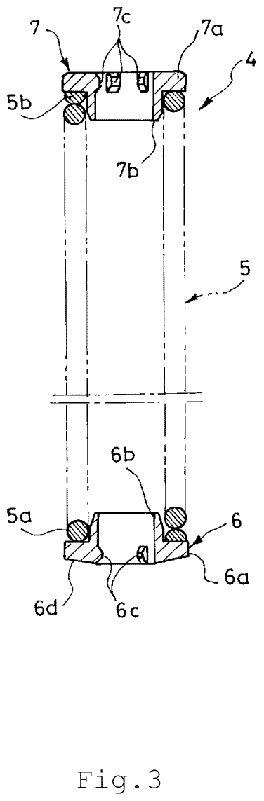

As illustrated in FIGS. 1 and 3, the coil spring 5 includes a coiled seat portion on the piston side end 5a at the lower end, and includes a coiled seat portion on the anti-piston side end 5b at the upper end in FIGS. 1 and 3.

In this case, the lower collar 6 is formed by a hard resin material and includes, as illustrated in FIG. 3, an annular seat portion 6a, a cylindrical fitting portion 6b rising from an inner peripheral side of a coil spring side end of the seat portion 6a and having an outer diameter smaller than that of the seat portion 6a, and a plurality of protrusions 6c provided on an inner periphery of the seat portion 6a. The lower collar 6 configured as described above is attached to the coil spring 5 by press-fitting the fitting portion 6b into the inner periphery of the piston side end 5a of the coil spring 5. Note that a distal end of the fitting portion 6b of the lower collar 6 has a tapered outer diameter, and the fitting portion 6b can be smoothly inserted into the piston side end 5a of the coil spring 5, so that the attachment work of the lower collar 6 to the coil spring 5 is facilitated.

A lower end surface in FIG. 2 of the seat portion 6a, which is a piston side end surface 6d of the lower collar 6, is an inclined surface that gradually separates from the piston 2 toward the outer peripheral side, and in the shock absorber D of the present embodiment, an inclination angle α of the inclined surface is an angle smaller than 20 degrees obtained by subtracting 90 degrees from the angle θ formed by the cylindrical portion 8a and the receiving portion 8b in the cross section of the support 8.

Note that, in the present embodiment, three protrusions 6c are provided at equal intervals in a circumferential direction on the inner periphery of the lower collar 6, and abuts on the outer periphery of the piston rod 3 inserted into the inner periphery with a tightening force to fix the lower collar 6 to the outer periphery of the piston rod 3. Note that the number of protrusions 6c only needs to be three or more, and can be arbitrarily changed. In addition, the lower collar 6 has the piston side end surface 6d, which is an inclined surface, abutting on the receiving portion 8b of the support 8, and downward movement of the rebound spring 4 with respect to the piston rod 3 in FIG. 1 is restricted.

Since the inclination angle α in the piston side end surface 6d of the lower collar 6 is an angle smaller than 20 degrees obtained by subtracting 90 degrees from the angle θ formed by the cylindrical portion 8a and the receiving portion 8b in the cross section of the support 8, the outer periphery of the piston side end surface 6d of the lower collar 6 is in line contact with the receiving portion 8b of the support 8 in a state where no load acts.

In this case, the upper collar 7 is formed by a hard fiber-reinforced resin and includes, as illustrated in FIG. 3, an annular seat portion 7a, a cylindrical fitting portion 7b rising downward from an inner peripheral side of a coil spring side end of the seat portion 7a and having an outer diameter smaller than that of the seat portion 7a, and a plurality of annular protrusions 7c provided inward on an inner periphery of the seat portion 7a.

The upper collar 7 configured as described above is attached to the coil spring 5 by press-fitting the fitting portion 7b into an inner periphery of a coiled seat on the anti-piston side end 5b of the coil spring 5. An outer diameter of a distal end of the fitting portion 7b of the upper collar 7 is tapered, and the fitting portion 7b can be smoothly inserted into the anti-piston side end 5b of the coil spring 5, so that the attachment work of the upper collar 7 to the coil spring 5 is facilitated.

Then, in the shock absorber D configured as described above, when the upper collar 7 abuts on the rod guide 9 and the coil spring 5 is compressed during the extension operation in which the piston 2 moves upward in FIG. 1, the coil spring 5 generates a spring force that hinders the piston 2 from moving upward in FIG. 1. Further, during the extension operation, the shock absorber D generates a difference between the pressure of the extension side chamber R1 and the pressure of the compression side chamber R2 as described above, and generates a damping force that hinders the upward movement of the piston 2 in FIG. 1. Therefore, in a situation where the rebound spring 4 is compressed when the shock absorber D is in the extension operation, the force exerted by the shock absorber D is the sum of the spring force that hinders the movement of the piston 2 generated by the rebound spring 4 and the damping force that hinders the movement of the piston 2 due to the pressure difference.

As described above, when the shock absorber D extends and the upper collar 7 abuts on the rod guide 9, the coil spring 5 contracts to generate a spring force, and thus the lower collar 6 is pressed against the receiving portion 8b of the support 8 by the spring force.

Since the angle θ formed by the cylindrical portion 8a and the receiving portion 8b in the cross section of the support 8 is larger than 90 degrees, the internal stress in the support 8 formed by bending a pipe material at an intermediate portion is reduced, and the durability of the support 8 is improved. In addition, in the cross section of the support 8, the angle θ formed by the cylindrical portion 8a and the receiving portion 8b is larger than 90 degrees, and the receiving portion 8b has a disc spring shape, and the strength of the support 8 against a load that causes the diameter of the receiving portion 8b to increase toward the cylindrical portion 8a side is significantly higher than when the angle θ is 90 degrees. Therefore, since the durability and strength of the support 8 are improved without increasing the thickness of the support 8, the deformation in which the diameter of the receiving portion 8b expands when receiving the spring force from the coil spring 5 is suppressed, and deformation in which an outer periphery of the receiving portion 8b is bent toward the cylindrical portion 8a side as in the conventional support 100 can be prevented.

As described above, the shock absorber D of the present embodiment includes the cylinder 1, the piston 2 slidably inserted into the cylinder 1, the piston rod 3 movably inserted into the cylinder 1 and having one end connected to the piston 2, the rebound spring 4 including the coil spring 5 disposed on the outer periphery of the piston rod 3 and the annular lower collar 6 attached to the piston side end 5a of the coil spring 5 and fitted to the outer periphery of the piston rod 3, the annular support 8 attached to the outer periphery of the piston rod 3, facing the lower collar 6 in the axial direction, and supporting the piston side end of the lower collar 6, in which the support 8 includes the cylindrical portion 8a attached to the outer periphery of the piston rod 3, and the receiving portion 8b that is annular, has an inner periphery connected to an anti-piston side end of the cylindrical portion 8a, faces a piston side end of the lower collar 6 in the axial direction, and is capable of abutting on the lower collar 6, and a regulating portion that regulates eccentricity of the lower collar 6 with respect to the receiving portion 8b is provided.

With the shock absorber D configured as described above, since the eccentricity of the lower collar 6 with respect to the support 8 is regulated by the regulating portion and the lower collar 6 is not displaced in the radial direction, it is possible to prevent a large moment from being applied to the receiving portion 8b when the rebound spring 4 is compressed. Thus, with the shock absorber D configured as described above, without increasing the thickness of the support 8, deformation in which the outer periphery of the receiving portion 8b is bent toward the cylindrical portion 8a due to the spring force received from the rebound spring 4 when the shock absorber D extends can be suppressed. As described above, with the shock absorber D of the present embodiment, since the durability and strength of the support 8 can be improved and bending deformation can be suppressed without increasing the thickness of the support 8, deformation of the support 8 can be prevented without increasing the manufacturing cost and the weight.

Further, in the shock absorber D of the present embodiment, the regulating portion is formed by setting the angle formed by the receiving portion 8b and the cylindrical portion 8a in the cross section of the support 8 to be larger than 90 degrees. With the shock absorber D configured as described above, the strength of the support 8 can be improved by setting the angle formed by the receiving portion 8b and the cylindrical portion 8a in the cross section of the support 8 to be larger than 90 degrees, and the regulating portion that regulates eccentricity of the lower collar 6 with respect to the receiving portion 8b can be formed, so that the manufacturing cost can be reduced.

Here, when the lower collar 6 is supported by the conventional support 100, the fitting portion 6b is fitted to the inner periphery of the coiled seat portion of the piston side end 5a of the coil spring 5, the tightening force in a radial reduction direction always acts on the fitting portion 6b, and when the spring force of the rebound spring 4 is received, the receiving portion 100b of the support 100 is also bent and deformed, and a moment to bend the outer periphery of the seat portion 6a of the lower collar 6 toward the piston 2 side with respect to the inner periphery acts. Thus, in the structure of the conventional support 100, a large tensile force acts between the fitting portion 6b receiving the tightening force in the radial reduction direction from the coil spring 5 and the seat portion 6a receiving a moment by receiving the spring force generated by compression of the coil spring 5, and the lower collar 6 is fatigued.

However, in the shock absorber D of the present embodiment, the angle θ formed by the receiving portion 8b and the cylindrical portion 8a in the cross section of the support 8 is set to be larger than 90 degrees, and the regulating portion is formed with the piston side end surface 6d of the lower collar 6 as an inclined surface, and the inclination angle α in the piston side end surface 6d is an angle smaller than an angle obtained by subtracting 90 degrees from the angle θ formed by the cylindrical portion 8a and the receiving portion 8b in the cross section of the support 8. Therefore, the outer periphery of the piston side end surface 6d of the lower collar 6 abuts on the receiving portion 8b of the support 8. In the shock absorber D configured as described above, when a load in the axial direction is applied from the rebound spring 4 to the seat portion 6a of the lower collar 6, the lower collar 6 receives a moment that causes the inner peripheral side of the seat portion 6a to approach the receiving portion 8b, and thus a tensile force acting between the fitting portion 6b and the seat portion 6a due to a tightening force that the fitting portion 6b receives from the coil spring 5 can be alleviated by the moment. Thus, with the shock absorber D configured as described above, fatigue of the lower collar 6 can be reduced even if the lower collar 6 repeatedly receives the spring force from the coil spring 5. Note that, in the drawing, the piston side end surface 6d of the lower collar 6 is formed as a tapered surface to form an inclined surface, but even in this case, the inclined surface may be formed as a curved surface other than the tapered surface as long as the outer periphery of the piston side end 6d of the lower collar 6 can be set to abut on the receiving portion 8b of the support 8.

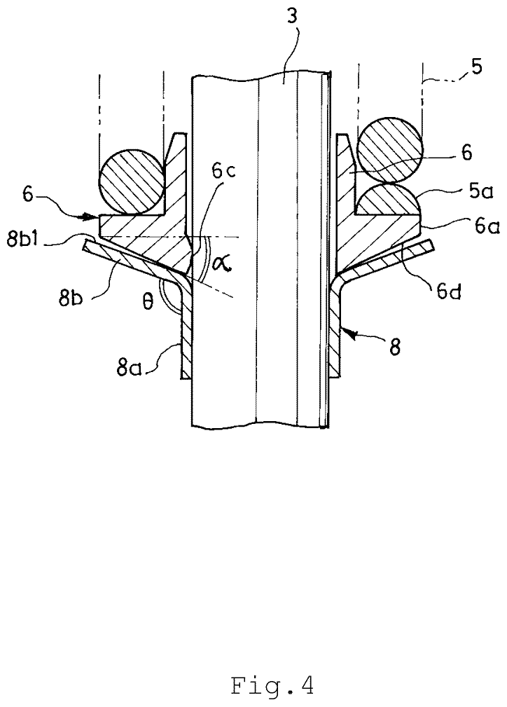

Further, as illustrated in FIG. 4, when the angle θ formed by the receiving portion 8b and the cylindrical portion 8a in the cross section of the support 8 is set to be larger than 90 degrees, the regulating portion is formed with the piston side end surface 6d of the lower collar 6 as an inclined surface, and the inclination angle α in the piston side end surface 6d is set to be larger than an angle obtained by subtracting 90 degrees from the angle θ formed by the cylindrical portion 8a and the receiving portion 8b in the cross section of the support 8, the inner periphery of the piston side end surface 6d of the lower collar 6 abuts on the receiving portion 8b of the support 8. In the shock absorber D configured as described above, since the spring force generated by compression of the coil spring 5 is transmitted to the receiving portion 8b of the support 8 through the inner periphery of the lower collar 6, a line of action of the load received from the rebound spring 4 passes through the thickness of the cylindrical portion 8a of the support 8 or the vicinity of the outer periphery of the cylindrical portion 8a, so that the moment of bending the outer periphery of the receiving portion 8b toward the cylindrical portion 8a can be quite small, and the deformation suppressing effect of the receiving portion 8b can be enhanced.

Note that, in a case where the angle θ formed by the receiving portion 8b and the cylindrical portion 8a in the cross section of the support 8 is set to be larger than 90 degrees, the regulating portion is formed with the piston side end surface 6d of the lower collar 6 as the inclined surface, and the inclination angle α in the piston side end surface 6d is equal to an angle obtained by subtracting 90 degrees from the angle θ formed by the cylindrical portion 8a and the receiving portion 8b in the cross section of the support 8, fatigue of the lower collar 6 can be reduced even when a repeated spring force is received from the coil spring 5, and the deformation suppressing effect of the receiving portion 8b can be enhanced. However, in order to set the inclination angle α and the angle obtained by subtracting 90 degrees from the angle 9 to be equal to each other in this manner, it is necessary to strictly manage the dimensions of the lower collar 6 and the support 8. Therefore, in consideration of mass productivity of the lower collar 6 and the support 8, in a case where it is desired to reduce fatigue of the lower collar 6, setting the inclination angle α to an angle smaller than an angle obtained by subtracting 90 degrees from the angle 9 is superior in that it is easier to be manufactured than setting the inclination angle α to be equal to the angle obtained by subtracting 90 degrees from the angle 9, and in a case where it is desired to enhance the deformation suppressing effect of the receiving portion 8b, setting the inclination angle α to be larger than an angle obtained by subtracting 90 degrees from the angle θ is superior in that it is easier to be manufactured than setting the inclination angle α to be equal to the angle obtained by subtracting 90 degrees from the angle 9.

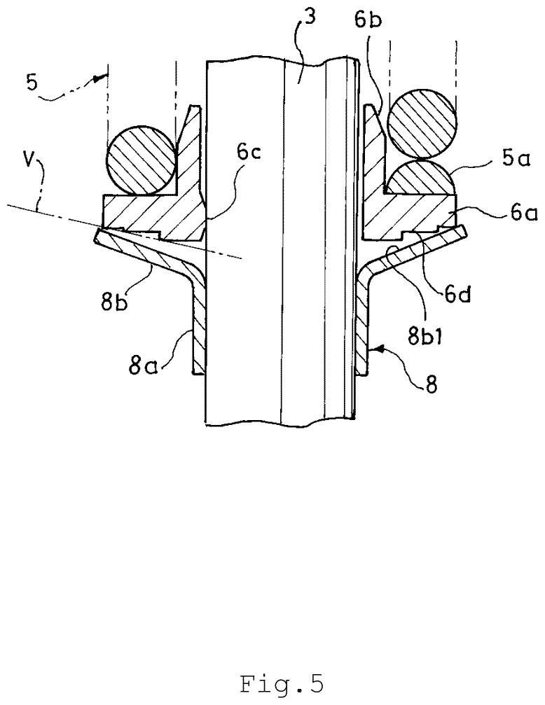

In the above description, the piston side end surface 6d of the lower collar 6 is an inclined surface, but as illustrated in FIG. 5, the piston side end surface 6d may be formed in a stepwise shape so that an outer diameter of the seat portion 6a increases stepwise. When the piston side end surface 6d is formed in a stepped shape in this manner, a virtual plane V passing through an edge of the stepped portion becomes an inclined surface. Thus, if the inclination angle of the virtual plane V is made smaller than the angle obtained by subtracting 90 degrees from the angle θ formed by the cylindrical portion 8a and the receiving portion 8b in the cross section of the support 8, the outer peripheral side of the seat portion 6a abuts on the receiving portion 8b, so that fatigue of the lower collar 6 can be reduced. Further, if the inclination angle of the virtual plane V is made larger than the angle obtained by subtracting 90 degrees from the angle 9 formed by the cylindrical portion 8a and the receiving portion 8b in the cross section of the support 8, the inner peripheral side of the seat portion 6a abuts on the receiving portion 8b, so that the deformation suppressing effect of the receiving portion 8b can be enhanced. As described above, in the category in which the piston side end surface 6d of the lower collar 6 is an inclined surface, the piston side end surface 6d of the lower collar 6 is formed in a stepwise shape, and the virtual plane V passing through the edge of the stepped portion is formed as an inclined surface.

Note that the piston side end surface 6d of the seat portion 6a in the lower collar 6 need not be an inclined surface but may be a surface that is not inclined or an inclined surface that is inclined in a direction opposite to the inclined surface illustrated in FIG. 2 or FIG. 4, and also in this case, the outer periphery of the piston side end surface 6d of the lower collar 6 abuts on the receiving portion 8b of the support 8, and thus fatigue of the lower collar 6 can be reduced even when the lower collar 6 repeatedly receives the spring force from the coil spring 5.

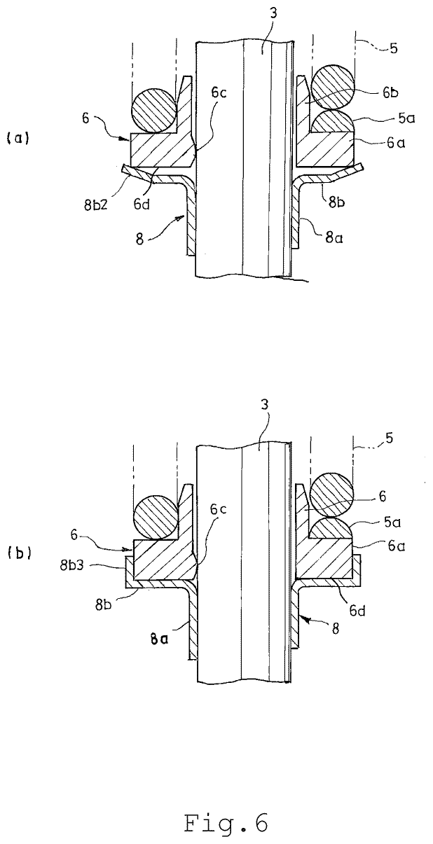

In addition, as illustrated in FIG. 6(a), a regulating portion that regulates eccentricity of the lower collar 6 with respect to the receiving portion 8b may be formed by making only an outer peripheral portion 8b2 of the receiving portion 8b in the cross section of the support 8 inclined, and setting an angle formed by the outer peripheral portion 8b2 of the receiving portion 8b and the cylindrical portion 8a to be larger than 90 degrees. Furthermore, as illustrated in FIG. 6(b), a regulating portion that regulates eccentricity of the lower collar 6 with respect to the receiving portion 8b may be formed in a shape obtained by folding back the outer peripheral portion 8b2 of the receiving portion 8b, in which an angle formed by the outer peripheral portion 8b3 of the receiving portion 8b and the cylindrical portion 8a is set to 180 degrees or more, and the outer peripheral portion 8b3 faces the outer periphery of the seat portion 6a of the lower collar 6.

In addition, a groove or a recess may be provided on the piston side end surface 6d of the lower collar 6 for the purpose of suppressing noise from hitting the receiving portion 8b, or the like.

Although the preferred embodiment of the present invention has been described above in detail, modifications, variations, and changes can be made thereto without departing from the claims.

### REFERENCE SIGNS LIST

1 Cylinder
2 Piston
3 Piston rod
4 Rebound spring
5 Coil spring
6 Lower collar
6d Piston side end surface of lower collar
8 Support
8a Cylindrical portion
8b Receiving portion (regulating portion)
8b2, 8b3 Outer peripheral portion of receiving portion (regulating portion)

1. A shock absorber comprising:
a cylinder;
a piston slidably inserted into the cylinder;
a piston rod movably inserted into the cylinder and having one end connected to the piston;
a rebound spring including a coil spring disposed on an outer periphery of the piston rod and an annular lower collar attached to a piston side end of the coil spring and fitted to the outer periphery of the piston rod; and
an annular support attached to the outer periphery of the piston rod, facing the lower collar in an axial direction, and supporting a piston side end of the lower collar, wherein
the support includes a cylindrical portion attached to the outer periphery of the piston rod, and a receiving portion that is annular, has an inner periphery connected to an anti-piston side end of the cylindrical portion, faces a piston side end of the lower collar in the axial direction, and is capable of abutting on the lower collar, wherein
a regulating portion that regulates eccentricity of the lower collar with respect to the receiving portion is provided.

2. The shock absorber according to claim 1, wherein
the regulating portion is formed by inclining an outer periphery of the receiving portion toward an anti-piston side.

3. The shock absorber according to claim 1, wherein
the regulating portion regulates the eccentricity by causing the receiving portion to abut on only an outer peripheral side of the lower collar.

4. The shock absorber according to claim 1, wherein
the regulating portion regulates the eccentricity by causing the receiving portion and an inner peripheral side of the lower collar to abut on each other.

5. The shock absorber according to claim 1, wherein
the regulating portion is formed by setting an angle formed by the receiving portion and the cylindrical portion in a cross section of the support to be larger than 90 degrees.

6. The shock absorber according to claim 1, wherein
the regulating portion is formed by setting an angle formed by the receiving portion and the cylindrical portion in a cross section of the support to be larger than 90 degrees and making a piston side end surface of the lower collar an inclined surface that gradually moves away from the piston toward an outer peripheral side toward the piston side end, and
an inclination angle of the inclined surface of the lower collar is smaller than an angle obtained by subtracting 90 degrees from the angle in the cross section of the support.

7. The shock absorber according to claim 1, wherein
the regulating portion is formed by setting an angle formed by the receiving portion and the cylindrical portion in a cross section of the support to be larger than 90 degrees and making a piston side end surface of the lower collar an inclined surface that gradually moves away from the piston toward an outer peripheral side toward the piston side end, and
an inclination angle of the inclined surface of the lower collar is larger than an angle obtained by subtracting 90 degrees from the angle in the cross section of the support.

8. The shock absorber according to claim 1, wherein
the regulating portion is formed in a shape obtained by folding back an outer peripheral portion of the receiving portion in a cross section of the support, in which an angle formed by the outer peripheral portion and the cylindrical portion is set to 180 degrees or more, and the outer peripheral portion faces an outer periphery of the lower collar.

9. The shock absorber according to claim 1, wherein
the lower collar has, on an inner periphery, three or more protrusions abutting on the outer periphery of the piston rod.
